(19) United States
(12) Patent Application Publication
(10) Pub. No.: US 2003/0184636 A1
(43) Pub. Date: Oct. 2, 2003

(54) Image receptive material comprising cationically charged inorganic particles

(76) Inventors: Paul D. Graham, Woodbury, MN (US); Mark F. Schulz, Lake Elmo, MN (US)

Correspondence Address: 3M INNOVATIVE PROPERTIES COMPANY, PO BOX 33427, ST. PAUL, MN, 55133-3427, US

(21) Appl. No.: 10/361,413

(22) Filed: Feb. 11, 2003

Related U.S. Application Data
(60) Provisional application No. 60/357,863, filed on Feb. 19, 2002.

(51) Int. Cl. B41J 2/01

(52) U.S. Cl. 347/105

(57) ABSTRACT

The present invention provides ink receptive materials containing cationically charged inorganic particles and uses thereof. The present invention also provides ink receptive materials containing inorganic particles.

### CROSS REFERENCE TO RELATED APPLICATION

This application claims priority to U.S. Provisional Patent Application No. 60/357,863, filed Feb. 19, 2002.

### BACKGROUND

The present invention relates to ink receptive materials containing cationically charged inorganic particles and uses thereof. The present invention also relates to ink receptive materials containing inorganic particles.

To create a durable, high-quality image with an inkjet printer, careful attention must be given to the interactions between the ink and the imaging substrate. Proper control of such interactions often requires that a specially designed ink-receptive coating be applied to the film substrate of interest before the image is applied. Many inkjet inks are comprised of a relatively small amount of colorant materials that are dissolved or dispersed into a suitable vehicle. In many cases, the generation of high-quality images requires the ink-receptive coating to be designed so that it is able to absorb the ink vehicle before the ink is able to smear, run, or irregularly coalesce. For aqueous inkjet inks, suitable ink absorption is sometimes accomplished via the inclusion of water-swellable polymers into the ink-receptive coating.

Because the colorants used in aqueous inkjet inks may readily dissolve and/or re-disperse in water and/or organic solvents, the creation of high-durability images requires that the coating is comprised of materials capable of forming durable bonds to the colorant, that is, mordants.

In applications where image durability is particularly important, it would be desirable to include high levels of mordants in image receptors to bond as many of the colorant molecules as possible. However, the incorporation of high levels of mordants in ink-receptive coatings may result in images having poor image quality. Poor image quality results because mordants are often not sufficiently water swellable to adequately control the final placement of the wet ink and to produce an image that is dry to the touch in a reasonable amount of time. Often, water-swellable materials are poor mordants.

As a second example, coatings comprised of the relatively high amount of the inorganic particles necessary to mordant certain colorants are often so brittle that they are impractical.

### SUMMARY

In one aspect, the invention provides an ink receptor composition comprising or consisting essentially of, cationically charged inorganic particles. In another aspect, the invention provides an ink receptor composition comprising or consisting essentially of, cationically charged inorganic particles and an organic binder. In another aspect, the invention provides an ink receptor composition comprising or consisting essentially of, cationically charged inorganic particles and a mordant. In another aspect, the invention provides an ink receptor composition comprising or consisting essentially of, cationically charged inorganic particles, and organic binder, and a mordant.

In another aspect, the invention provides an ink receptor medium comprising a substrate having a surface that is substantially smooth, microembossed, beaded, or combinations thereof, and an ink receptor comprising or consisting essentially of cationically charged inorganic particles.

### DETAILED DESCRIPTION

An ink receptor composition of the invention comprises inorganic particles. Useful inorganic particles usually have a substantially positive charge on their surface (cationic) and are often supplied in acidic media. Examples of useful inorganic particles include, but are not limited to, particles comprised of silica, alumina, or zirconia and inorganic metal oxides including ceria, zinc oxide, vanadium oxide, tin oxide, etc. Examples of particularly useful inorganic particles include alumina-coated silica particles prepared with an acetate stabilizing ion (for example, TX11608, available from Ondeo Nalco Company, Chicago, Ill.) and zirconia particles prepared with an acetate stabilizing ion (i.e., 00SS008 Zirconia sol, available from Ondeo Nalco Company, Chicago, Ill.). Useful inorganic particles are generally included into the ink receptor in an amount sufficient to form suitable interactions with the dyestuffs or colorant. The ink receptor compositions containing inorganic particles may contain about 1 to 100 percent dry weight percent inorganic particles, preferably from about 30 to about 100 percent dry weight percent inorganic particles, more preferably about 50 to about 100 percent dry weight percent inorganic particles and even more preferably from about 60 to about 95 percent dry weight percent inorganic particles.

The ink receptor compositions comprising inorganic particles may contain one or more mordants. A “mordant” as used herein is a material that forms a bond with dyestuffs or colorants in inks. A mordant is used to fix the ink dyestuffs so to provide increased durability to images, particularly water resistance. Useful mordants may include materials that are both water swellable and form a bond with dyestuffs or colorants in inks. Other useful mordants are those materials or compounds that contain cationic moieties, for example, quaternary amino groups. Desirably, the mordants do not interfere with the interactions between the inorganic particles and the dyestuffs or colorants in inks.

Useful mordants include, but are not limited to, FREETEX 685 (a polyquaternary amine, available from Noveon, Inc., Cleveland, Ohio), DYEFIX 3152 (an ammonium chloride-cyanoguanidine-formaldehyde copolymer, available from Bayer, Pittsburgh, Pa.), GLASCOL F207 (2-Propen-1-aminium, N,N-dimethyl-N-2-propenyl-, chloride, homopolymer, available from Ciba Specialty Chemicals), ECCOFIX FD-3 (a hydroxy-functional polyamide available from Eastern Color and Chemical, Providence, R.I.), SYNTRAN HX 31-65, SYNTRAN HX 31-44 (available from Interpolymer, Louisville, Ky., both of which are copolymers wherein one of the monomers is selected from the group comprising alkyl methacrylate and alkyl acrylate, and one of the other monomers is selected from the group comprising quaternized dialkylaminoalkyl methacrylate and methyl quaternized dialkylaminoalkyl acrylate).

The formation of suitable interactions with dyestuffs or colorants in inks may require the combination of inorganic particles and mordants. Useful combinations include alumina particles (such as DISPAL 18N4-80 dispersible colloidal alumina, available from Sasol Ltd., Houston, Tex.) with mordants such as polyquaternary amines (for example FREETEX 685, available from Noveon, Inc., Cleveland, Ohio), hydroxy-functional polyamides (for example ECCOFIX FD-3, available from Eastern Color and Chemical, Providence, R.I.), copolymers wherein one of the monomers is selected from the group comprising alkyl methacrylate and alkyl acrylate, and one of the other monomers is selected from the group comprising quaternized dialkylaminoalkyl methacrylate and methyl quaternized dialkylaminoalkyl acrylate (for example SYNTRAN HX 31-65, SYNTRAN HX 31-44, both available from Interpolymer, Louisville, Ky.), and combinations thereof. A useful receptor composition comprises alumina particles (for example DISPAL 18N4-80 dispersible colloidal alumina, available from Sasol Ltd., Houston, Tex.), polyquaternary amines (for example FREETEX 685, available from Noveon, Inc., Cleveland, Ohio), and hydroxy-functional polyamides (for example ECCOFIX FD-3, available from Eastern Color and Chemical, Providence, R.I.).

The ink receptor compositions of the invention may contain up to about 80, up to about 70, up to about 60, up to about 50, up to about 40, up to about 30, up to about 20, or up to about 10 dry weight percent mordant. In other embodiments, the ink receptor compositions may contain 1 or greater, 5 or greater, 10 or greater, 20 or greater, 30 or greater, 40 or greater, or 50 or greater weight percent mordant on a dry basis. In other embodiments, the ink receptor compositions of the invention may contain from about 40 to about 90 dry weight percent mordant and any whole or fractional amount in between about 40 and about 90 dry weight percent. Water-swellable materials that do not bond to dyestuffs or colorants in inks are not used in inorganic particle ink receptor compositions of the invention are also useful. The ink receptor compositions of the invention may also contain one or more crosslinkers.

Optionally, a polymeric binder may be added to the ink receptor comprising inorganic particles to improve the adhesion between the particles and a substrate. Useful polymeric binders provide adhesion to both the particles and the substrate and are compatible with the dispersion of inorganic particles. Poly(ethylene-co-vinyl acetate)-based polymers (such as those marketing by Air Products and Chemicals, Allentown, Pa., by the AIRFLEX trade designation) and aromatic polyurethane-based polymers (such as those marketed by Zeneca Resins, Wilmington, Mass., by the NeoRez trade designation) are examples. Particularly useful polymeric binders include AIRFLEX 400 (a poly(ethylene-co-vinyl acetate)-based emulsion, available from Air Products and Chemicals, Allentown, Pa.) and XR-9249 (an aromatic polyurethane-based polymeric emulsion, available from Zeneca Resins, Wilmington, Mass.). The polymeric binder may be generally included into the ink receptor in an amount sufficient to improve the adhesion between the inorganic particles and the substrate. The ink receptor compositions containing inorganic particles may include up to about 80 dry weight percent polymeric binder, preferably up to about 50 dry weight percent polymeric binder, more preferably from about 5 to about 40 dry weight percent polymeric binder, and even more preferably from about 5 to about 30 dry weight percent polymeric binder.

In another aspect, the invention comprises an ink receptor medium comprising a microembossed substrate comprising microembossed elements and an ink receptor comprising cationically charged inorganic particles on the microembossed surface. Preferably, the microembossed element is a cavity, post, or combination thereof. A “microembossed” surface has a topography wherein the average microembossed element pitch, that is, center to center distance between nearest elements is from about 1 to about 1,000 micrometers and may be any whole or fractional pitch in between 1 and 1,000 micrometers and the average peak to valley distances of individual elements is from about 1 to about 150 micrometers and any whole or fractional peak to valley distance between 1 and 150 micrometers. Preferably, if the microembossed elements are posts, the space between posts (pitch) is from about 10 to about 500 micrometers and any whole or fractional pitch between 10 and 500 micrometers, the posts have a height of from about 10 to about 100 micrometers, and diameters of not more than 100 micrometers and not less than 5 micrometers and any whole of fractional diameter between 5 and 100 micrometers.

In a particular embodiment, the microembossed surface comprises microembossed cavities. The volume of a cavity should preferably be at least 10 pL, and more preferably at least 30 pL. The volume of a cavity can range from about 10 pL to about 10,000 pL and may be any volume or volume range between 10 pL and 10,000 pL, and preferably from about 60 pL to about 8,000 pL and may be any volume or volume range between 60 pL and 8,000 pL. Other useful ranges of cavity volume include from about 200 pL to about 8,000 pL, and from about 300 pL to about 6,000 pL and may be any volume or range of volumes between 200 pL and 8,000 pL. Examples of topographies for cavities include conical cavities with angular, planar walls; truncated pyramid cavities with angular, planar walls; and cube-corner shaped cavities. Cavity depths can range from about 15 to about 150 micrometers and may be any depth or range of depths between 15 and 150 micrometers.

The microembossed pattern may be regular or random as described in U.S. Pat. No. 6,386,699; U.S. application Ser. No. 09/583,295, filed on May 31, 2000, also WO 00/73082; and U.S. application Ser. Nos. 10/183,122 and 10/183,121, filed on Jun. 25, 2002, respectively, incorporated by reference for the description of microembossed substrates and methods of making said substrates.

The substrate used in the ink receptor medium can generally be made from any polymer capable of being microembossed by methods known in the art. The substrate can be a solid film. The substrate can be transparent, translucent, or opaque, depending on desired usage. The substrate can be clear or tinted, depending on desired usage. The substrate can be optically transmissive, optically reflective, or optically retroreflective, depending on desired usage. The materials of the substrate may also depend upon the durability requirements of an image for a particular application, for example, an identification or security card. For such applications, poly(butylene terephthalate)-containing materials are preferred.

Nonlimiting examples of polymeric materials for use in such substrates include thermoplastics, such as those comprising polyolefins, poly(vinyl chloride), copolymers of ethylene with vinyl acetate or vinyl alcohol, polycarbonate, poly(butylene terephthalate), norbornene copolymers, fluorinated thermoplastics such as copolymers and terpolymers of hexafluoropropylene and surface modified versions thereof, poly(ethylene terephthalate), and copolymers thereof, polyurethanes, polyimides, polyamides, acrylics, plasticized polyvinyl alcohols, blends of polyvinylpyrrolidone and ethylene acrylic acid copolymer (Primacor™, available from Dow Chemical Company) and filled versions of the above using fillers such as silicates, polymeric beads, aluminates, feldspar, talc, calcium carbonate, titanium dioxide, and the like. Also useful in the application are non-wovens, coextruded films, and laminated films made from the materials listed above.

Other useful substrates include substantially smooth substrates made from the materials listed above, and “beaded” substrates having exposed or partially exposed glass or polymeric beads or microbeads. Examples of exposed glass microbead substrates include those sold under the tradename CONFIRM Security Laminate, from 3M Company.

The ink receptor media of the invention may optionally have an adhesive layer on the major surface of the sheet opposite microembossed image surface that is also optionally but preferably protected by a release liner. After imaging, the ink receptor medium can be adhered to a horizontal or vertical, interior or exterior surface to warn, educate, entertain, advertise, etc.

The choice of adhesive and release liner depends on usage desired for the image graphic.

Pressure-sensitive adhesives can be any conventional pressure-sensitive adhesive that adheres to both the polymer sheet and to the surface of the item upon which the inkjet receptor medium having the permanent, precise image is destined to be placed. Pressure-sensitive adhesives are generally described in Satas, Ed., Handbook of Pressure Sensitive Adhesives, 2nd Ed. (Von Nostrand Reinhold 1989), the disclosure of which is incorporated herein by reference. Pressure-sensitive adhesives are commercially available from a number of sources. Particularly preferred are acrylate pressure-sensitive adhesives commercially available from 3M Company and generally described in U.S. Pat. Nos. 5,141,790; 4,605,592; 5,045,386; and 5,229,207; and EPO Patent Publication No. EP 0 570 515 B1 (Steelman et al.).

Release liners are also well known and commercially available from a number of sources. Nonlimiting examples of release liners include silicone coated Kraft paper, silicone coated polyethylene coated paper, silicone coated or non-coated polymeric materials such as polyethylene or polypropylene, as well as the aforementioned base materials coated with polymeric release agents such as silicone urea, urethanes, and long chain alkyl acrylates, such as defined in U.S. Pat. Nos. 3,957,724; 4,567,073; 4,313,988; 3,997,702; 4,614,667; 5,202,190; and 5,290,615; the disclosures of which are incorporated herein by reference and those liners commercially available as Polyslik brand liners from Rexam Release of Oakbrook, Ill., and EXHERE brand liners from P. H. Glatfelter Company of Spring Grove, Pa.

In another embodiment, the ink receptor media of the invention further comprises a backing layer attached or laminated to the un-embossed surface of the microembossed substrate. The backing layer is used to provide the microembossed ink receptor media with thickness and rigidity, for example, for use as an identification card. As may be appreciated, the backing layer may be made from any material, with water proof and abrasion resistant materials being typical. Examples of useful materials include thermoplastics including those listed above and poly(ethylene terephthalate), poly(ethylene terephthalate glycol), polycarbonates, polyimides, cellulose acetate, poly(ethylene naphthalate), and polypropylenes, such as biaxially oriented polypropylene. The backing layer may be attached to the microembossed substrate by means known to those skilled in the art such as lamination, adhesive, or tape, and the like.

The microembossed surface can be made from any contacting technique such as casting, coating, or compressing techniques. More particularly, micro-embossing can be achieved by at least any of (1) casting a molten thermoplastic using a tool having a pattern, (2) coating of a fluid onto a tool having a pattern, solidifying the fluid, and removing the resulting micro-embossed solid, or (3) passing a thermoplastic film through a heated nip roll to compress against a tool having a pattern. Desired embossing topography can be formed in tools via any of a number of techniques well-known to those skilled in the art, selected depending in part upon the tool material and features of the desired topography. Illustrative techniques include etching (e.g., via chemical etching, mechanical etching, or other ablative means such as laser ablation or reactive ion etching, etc.), photolithography, stereolithography, micromachining, knurling (e.g., cutting knurling or acid enhanced knurling), scoring or cutting, etc.

Alternative methods of forming the micro-embossed image surface include thermoplastic extrusion, curable fluid coating methods, and embossing thermoplastic layers which can also be cured.

The ink receptors of the invention are typically formulated to receive an image comprising aqueous ink. The ink may be applied to the ink receptor by any means and in particular by means of an inkjet print head. Useful colorants in the inks include dye based colorants and pigment based colorants. Other examples of inks that may be useful for imaging ink receptors of the invention include non-aqueous inks, phase change inks, and radiation polymerizable inks.

### EXAMPLES

All of the amounts given are by weight unless otherwise stated. Unless otherwise stated, all of the components are available from Aldrich Chemical Co., Milwaukee, Wis. Water used was de-ionized.

“TX-1 1608” is a trade designation for a 29 percent by weight dispersion of acetate-stabilized, alumina-coated colloidal silica, available from Ondeo Nalco Company, Chicago, Ill.

“AIRFLEX 400 EMULSION” is a trade designation for a 52 percent by weight latex emulsion, available from Air Products and Chemicals, Allentown, Pa.

“DISPAL 18N4-80” is a trade designation for dispersible colloidal alumina powder, available from Sasol Ltd., Houston, Tex.

“FREETEX 685” is a trade designation for a 50 percent by weight composition of a cationic polyamine, available from Noveon, Inc., Cleveland, Ohio.

“HELOXY MODIFIER 48” is a trade designation for a polyfunctional epoxy crosslinker, available from Resolution Performance Products, Houston, Tex.

“ECCOFIX FD-3” is a trade designation for a 30 percent by weight composition of a hydroxy-functional polyamide available from Eastern Color and Chemical, Providence, R.I.

“SYNTRAN HX 31-65” is a trade designation for a 35 percent by weight composition of an acrylic copolymer, available from Interpolymer, Louisville, Ky.

Microembossed Film

The microembossed film was made by extruding a molten film into the roll nip formed by the top two rolls of a three roll calendering stack. The middle roll was a patterned metal roll. A portion of the surface of the metal patterned roll was engraved with an orthogonal set of grooves. Each of the grooves were spaced about 125 micrometers apart, about 75 micrometers deep, about 18 micrometers wide at their bottom and about 36 micrometers wide at their tops. The grooves were cut in a helical pattern around the roll such that the direction of each groove was oriented about 45 degrees from the roll axis. The temperature of the metal patterned roll was maintained at about 137.8° C. (280° F.) to about 160° C. (320° F.) using an oil bath. Water at 60° C. (140° F.) was circulated through the top roll and water at 90.56° C. (195° F.) was circulated through the bottom roll.

### Example 1

An ink receiving composition was prepared by mixing 10 parts TX-11608, 5 parts water, 1.67 parts n-propyl alcohol, and 1.45 parts AIRFLEX 400 EMULSION. The composition was mixed after each component was added. This ink receiving composition was applied with a #10 Mayer rod (nominal wet thickness=0.023 mm) to the microembossed surface of a piece of microembossed film whose surface contained an array of square cavities that were about 70 micrometers deep and a microembossed element pitch of about 125 micrometers. The walls were about 18 micrometers thick at their top and about 36 micrometers at their bottom. The microembossed film was comprised of a 15:1 blend of CELANEX 1600A (a poly(butylene terephthalate), available from Ticona, Indianapolis, Ind.) and CELANEX 2020, color #EA3146K15 (a titanium dioxide containing color concentrate, available from Ticona) and was about 0.175 millimeters thick. The coated substrate was dried for five minutes in an oven at 70° C. (158° F.).

Several pieces of this the coated, microembossed film was attached with Scotch Brand Double Stick Tape (available from the 3M Company, St. Paul, Minn.) to a piece of about 0.550 millimeter thick PETG (poly(ethylene terephthalate glycol), available from the Eastman Chemical Co., Kingsport, Tenn.) sheet.

This material was then printed onto the coated side using a Hewlett-Packard 845C inkjet printer that was specially modified to print thick materials and was equipped with a cartridge containing the same aqueous pigmented inkjet inks as in Cartridge Nos. C1892A, C1893A, C1894A, and/or C1895A, available from Hewlett-Packard, Palo Alto, Calif. The resulting image exhibited high color density and excellent line sharpness with no bleed or feathering between colors.

Light finger pressure applied to the imaged surface of the film about two minutes after printing produce very little ink transfer. The imaged films were allowed to dry for about 24 hours before being placed into a standard laundry washing machine (Maytag, Model# LSE7804ACE) with 30 grams of AATCC 1993 Standard Reference Detergent (without optical brightener). The hot water and small load settings were used. The temperature of the hot water was about 43.33° C. (110° F.). After the imaged film went through the washing machine cycle, the image quality was virtually unchanged with very little bleed or feathering between colors.

### Example 2

The following compositions were prepared:

| | |
|---|---|
| Composition A: | Prepared by adding 6.25 parts DISPAL 18N4-80 to 18.75 parts |
| | water, then agitating vigorously in a high shear mixer for |
| | approximately 10 minutes. Then 40 parts water and 35 parts |
| | isopropanol were added with moderate mixing. |
| Composition B: | Prepared by mixing 10 parts FREETEX 685 with 55 parts water and |
| | 35 parts isopropanol. |
| Composition C: | Prepared by mixing 1 part HELOXY MODIFIER 48 with 39 parts |
| | isopropanol. |
| Composition D: | Prepared by mixing 16.7 parts ECCOFIX FD-3 with 48.3 parts |
| | water and 35 parts isopropanol. |
| Composition E: | Prepared by mixing 14.3 parts SYNTRAN HX31-65 with 42.9 parts |
| | isopropanol and 42.9 parts water. |
| Composition F: | Prepared by mixing 70 parts of Composition A, 30 parts of |
| | Composition B, and 1.2 parts of Composition C. |
| Composition G: | Prepared by mixing 70 parts of Composition A, 21 parts of |
| | Composition B, 9 parts of Composition D, and 1.2 parts of |
| | Composition C. |
| Composition H: | Prepared by mixing 30 parts of Composition A, 70 parts of |
| | Composition E, and 2.8 parts of Composition C. |

Compositions F, G, and H were each applied with a #10 Mayer rod (nominal wet thickness=0.023 mm) to a microembossed surface of a piece of corona-treated microembossed film whose surface contained an array of square cavities that were about 70 micrometers deep and a microembossed element pitch of about 125 micrometers. The walls were about 18 micrometers thick at their top and about 36 micrometers at their bottom. The corona treatment was applied to the microembossed surface by passing a high frequency generator (120 volts, 50/60 Hertz, 0.35 amps, available from Electro Technic Products Inc., Chicago, Ill.) throughout the film surface. The microembossed film was comprised of a blend of 5 parts of Fina 3376 Polypropylene (available from Fina Oil and Chemical Co., Dallas, Tex.) and 1 part of P White 2% 10151005S (a titanium dioxide containing color concentrate in polypropylene available from Clariant, Charlotte, N.C.). The coated substrate was dried for about five minutes in an oven at 70° C. (158° F.).

This coated material was then printed onto the coated side using a Canon P-640L inkjet printer equipped with its standard ink cartridges. The printed film was placed into a convection oven for about 90 minutes at 70° C. (158° F.).

The color density of a printed black square was measured using a Gretag SPM 55 spectrophotometer. This portion of the film was submerged in room temperature water for about 80 minutes. The film was allowed to dry for about 24 hours and the black density was re-measured using the Gretag SPM 55 spectrophotometer. The table below shows a comparison of the black density before and after water submersion.

Black Density

| Film Coating | Before submersion | After submersion |
|---|---|---|
| Composition F | 0.946 | 0.908 |
| Composition G | 0.969 | 0.944 |
| Composition H | 0.930 | 0.926 |

All patents, patent applications, and publications cited herein are each incorporated by reference, as if individually incorporated. Foreseeable modifications and alterations of this invention will be apparent to those skilled in the art without departing from the scope and spirit of this invention. This invention should not be restricted to the embodiments that are set forth in this application for illustrative purposes.

What is claimed is:

1. An ink receptor composition comprising cationically charged inorganic particles.

2. The ink receptor composition of claim 1 wherein the composition further comprises an organic binder.

3. The ink receptor composition of claim 1 wherein the inorganic particles comprise alumina, silica, zirconia, ceria, zinc oxide, vanadium oxide, tin oxide, or combinations thereof.

4. The ink receptor composition of claim 2 wherein the organic binder is selected from the group consisting of poly(ethylene-co-vinylacetate)-based polymers, aromatic polyurethane-based polymers, or combinations thereof.

5. The ink receptor composition of claim 1 wherein the composition further comprises a mordant.

6. The ink receptor composition of claim 2 wherein the composition further comprises a mordant.

7. The ink receptor composition of claim 5 wherein the mordant is selected from the group consisting of polyquaternary amines, ammonium chloride-cyanoguanidine-formaldehyde copolymers, hydroxy-functional polyamides, (2-Propen-1-aminium, N,N-dimethyl-N-2-propenyl-chloride homopolymer, copolymers of alkyl methacrylate or alkyl acrylate with quaternized dialkylaminoalkyl methacrylate or methyl quaternized dialkylaminoalkyl acrylate, and combinations thereof.

8. The ink receptor composition of claim 6 wherein the mordant is selected from the group consisting of polyquaternary amines, ammonium chloride-cyanoguanidine-formaldehyde copolymers, hydroxy-functional polyamides, (2-Propen-1-aminium, N,N-dimethyl-N-2-propenyl-chloride homopolymer, copolymers of alkyl methacrylate or alkyl acrylate with quaternized dialkylaminoalkyl methacrylate or methyl quaternized dialkylaminoalkyl acrylate, and combinations thereof.

9. An ink receptor medium comprising:
a substrate having a surface; and
a dried ink receptor composition of claim 1 on the surface.

10. The ink receptor medium of claim 9 wherein the surface of the substrate is substantially smooth, microembossed, or beaded.

11. The ink receptor medium of claim 10 wherein the microembossed surface comprises cavities, posts, or a combination of cavities and posts.

12. The ink receptor medium of claim 9 wherein the ink receptor composition further comprises an organic binder.

13. The ink receptor medium of claim 9 wherein the inorganic particles comprise alumina, silica, zirconia, ceria, zinc oxide, vanadium oxide, tin oxide, or combinations thereof.

14. The ink receptor medium of claim 12 wherein the organic binder is selected from the group consisting of poly(ethylene-co-vinylacetate)-based polymers, aromatic polyurethane-based polymers, or combinations thereof.

15. The ink receptor composition of claim 9 wherein the composition further comprises a mordant.

16. The ink receptor composition of claim 12 wherein the composition further comprises a mordant.

17. The ink receptor composition of claim 16 wherein the mordant is selected from the group consisting of polyquaternary amines, ammonium chloride-cyanoguanidine-formaldehyde copolymers, hydroxy-functional polyamides, (2-Propen-1-aminium, N,N-dimethyl-N-2-propenyl-chloride homopolymer, copolymers of alkyl methacrylate or alkyl acrylate with quaternized dialkylaminoalkyl methacrylate or methyl quaternized dialkylaminoalkyl acrylate, and combinations thereof.

18. A method of printing comprising the steps of:
applying ink to an ink receptor medium of claim 9 using an inkjet printer.
